(19) United States
(12) Patent Application Publication
(10) Pub. No.: US 2017/0296415 A1
(43) Pub. Date: Oct. 19, 2017

(54) Exercise vest to allow one person to easily lift patient out of wheelchair

(71) Applicant: Gerry Cook, Sandpoint, ID (US)

(72) Inventor: Gerry Cook, Sandpoint, ID (US)

(21) Appl. No.: 15/469,421

(22) Filed: Mar. 24, 2017

Related U.S. Application Data
(60) Provisional application No. 62/313,038, filed on Mar. 24, 2016.

(51) Int. Cl. A61G 7/10

(52) U.S. Cl. CPC A61G 7/1051; A61G 7/1001; A61G 7/1023

(57) ABSTRACT

An exercise vest including a thoracic belt fitting around a person's midsection. A padded elasticized and reinforced band attached to the thoracic belt at center back designed to come from back around in front of each shoulder and connect to unweighting system. Two elasticized and reinforced straps designed to attach in the front and come around each side of patient attach in an x pattern in the back and attach to the unweighting system. The exercise vest is positioned in such a way that as the patient is unweighted it cinches and hugs the person to distribute forces uniformly throughout a patient's torso, preventing wear on the person and strain on the device. This allows us to lift a patient upright out of a wheel chair in an easy, comfortable and safe manner.

The current state of the art, for vests used with unweighting systems, features vests that either have to be cinched extremely tight on a user to attempt to prevent the vest riding up and becoming uncomfortable for user or feature a strap between the legs which presents several problems—autonomic dysreflexia, altered gait, cumbersome and time consuming to put on somebody in a wheelchair, and lack of comfort to the user.

The present invention relates to an exercise vest for use with an unweighting system to unweight patients from minimal weight supported up to 100% of body weight supported. It is an object of the present invention to provide an exercise vest that is easy for a person to put on a user in a standing or seated position, and be able to remove any amount of body weight with the vest remaining in its original position and remaining comfortable for the patient even with maximum weight supported. As force is applied by the unweighting system, patient's upper torso is placed into an upright, elevated rib cage with shoulders back, allowing for maximum lung expansion.

### BRIEF DESCRIPTION OF THE DRAWINGS

FIG. 1 is a detail picture of the vest.

FIG. 2 is a detail picture of ischial tuberosity strap.

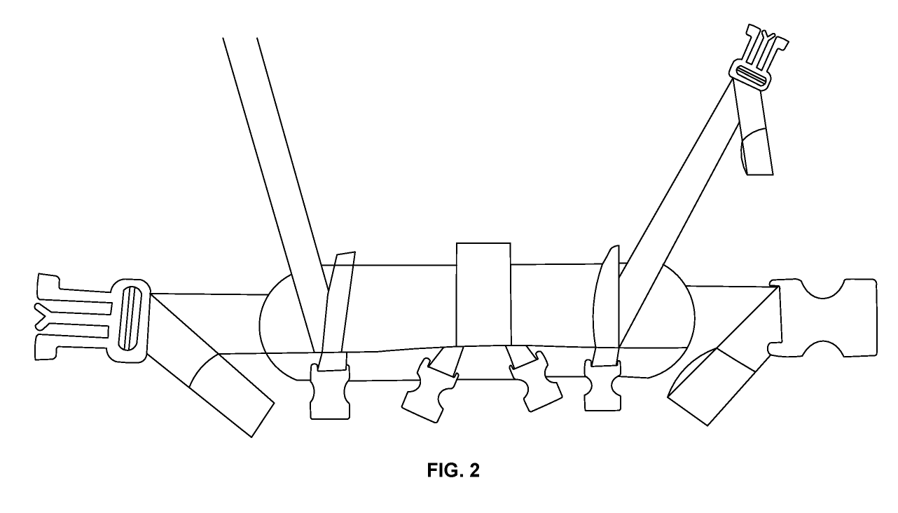

FIG. 3 is a front view of an exercise vest according to the present invention

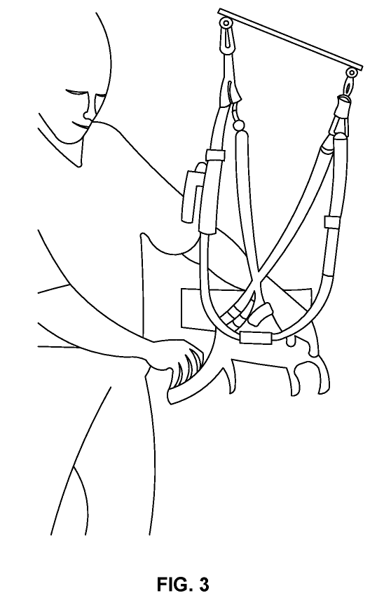

FIG. 4 is a front view of a user wearing the vest shown in FIG. 1

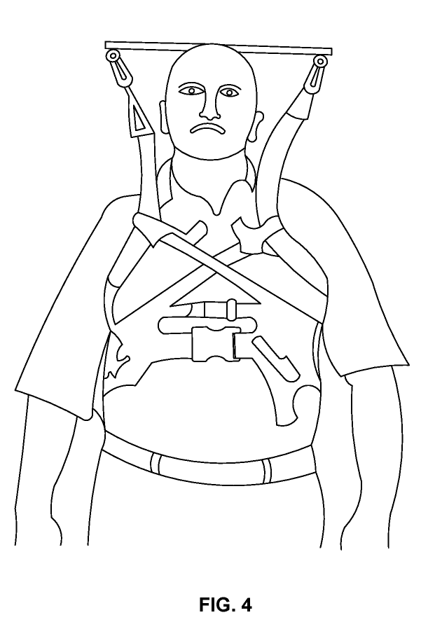

FIG. 5 is a back view of a user wearing the vest shown in FIG. 1.

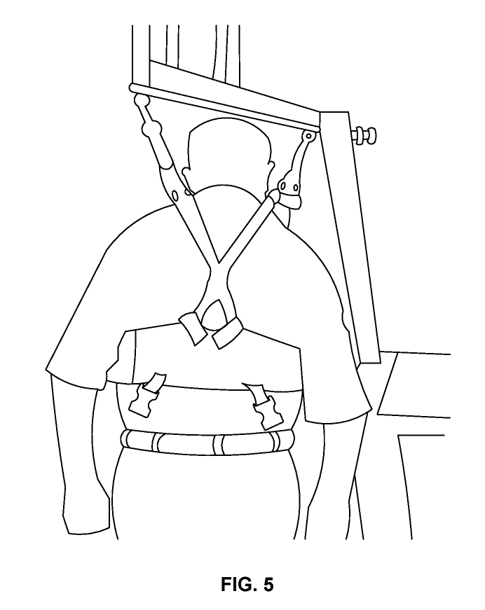

FIG. 6 is a front view of a user wearing the vest shown in FIG. 1 in conjunction with the ischial tuberosity strap.

FIG. 7 is a back view of a user wearing the vest shown in FIG. 1 in conjunction with the ischial tuberosity strap.

FIG. 8 is a detail picture of the ischial tuberosity strap.

FIG. 9 is a view of the full body weight removed from a user seated in a chair.

FIG. 10 is a view of the full body weight removed from a user suspended.

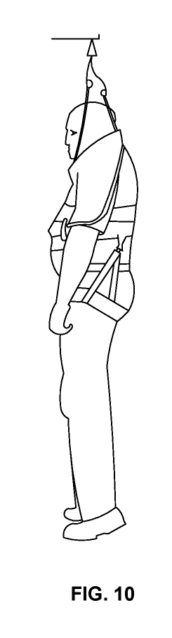

FIG. 11 is a strap end with elastic and buckle.

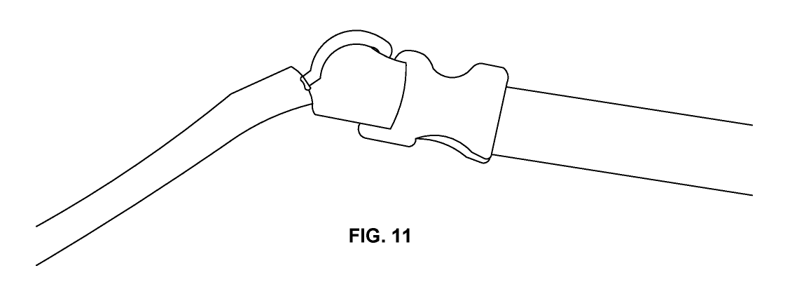

FIG. 12 is a strap end with elastic, buckle and flexible reinforced cover.

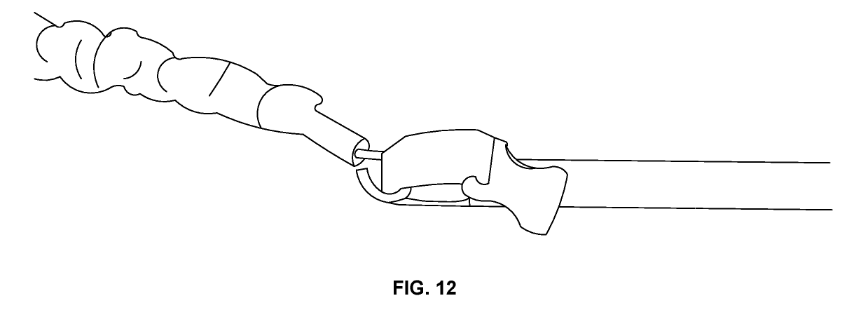

FIG. 13 is a strap end with elastic, buckle and adjustable nylon reinforced strap.

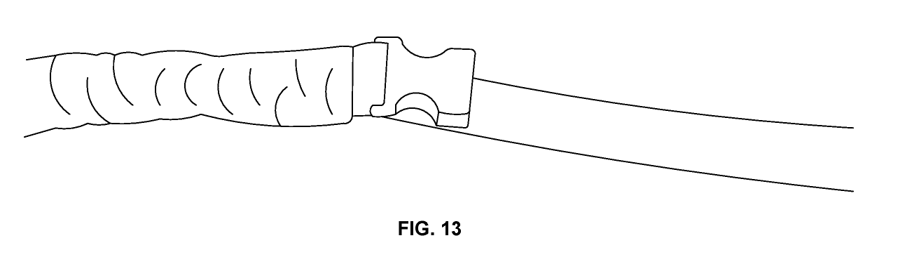

### DESCRIPTION OF A PREFERRED EMBODIMENT

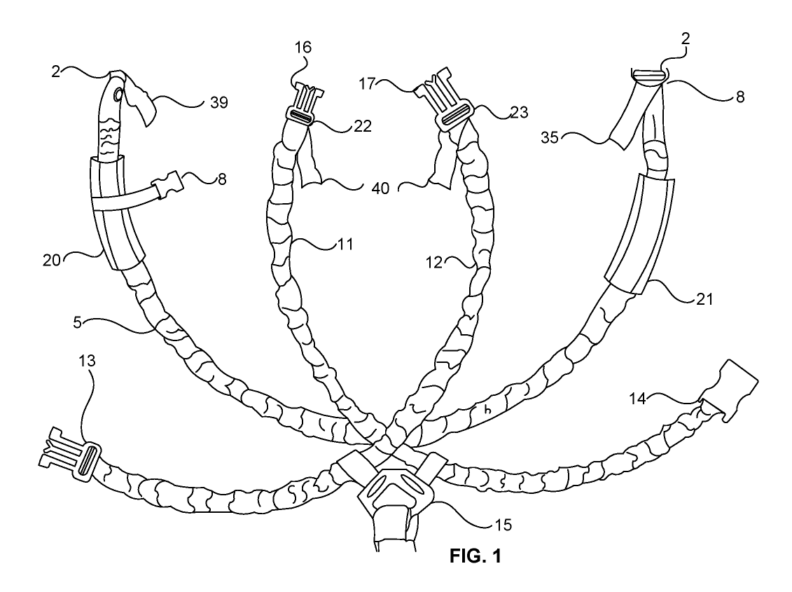

An exercise vest (1) according to the present invention is shown in FIG. 1. The vest (1) includes a thoracic belt having two ends which may be fastened together, as with a male (2) and female (3) buckle, around the midsection of the user. The thoracic belt may wrap around the stomach of the user, such that the thoracic belt sits below the rib cage and above the waist of the user. The thoracic belt includes connectors for an ischial tuberosity strap. The connectors for the ischial tuberosity strap may number four or more. There may be no connectors for the ischial tuberosity strap, or there may be less than four. The thoracic band belt includes connectors to an elasticized and/or reinforced band. These connectors may be nylon straps. These connectors are optionally attached to the band via a buckle. These connectors cross the body of the user. For example, a right side connecting mechanism attaches a connector on the right side of the thoracic band belt. This connector crosses the body of the user and connects to the band via a connector on a left side pad. For example, the pad on the band may be a pad that wraps around the band at a sensitive area of the body, such as where the band will experience wear from movement of the user's arm. The pad may have the female end of the connector attached. For example, a nylon strap may wrap around the pad and have the female end of a buckle attached at the end of the nylon strap. Via these cross-body connectors, the band and thoracic band belt exert cross directional force when the user is lifting via the unweighting system. For example, rather than merely lifting via exerting vertical force on the thoracic belt or the band, force is transferred via the connectors such that there is a cinching or hugging action. This hugging action distributes force over a larger area, so there is less stress at the lift points on the device and less stress on the user.

Attached at the back of the thoracic belt (4) will be an elasticized and/or reinforced band (5) designed to wrap around the thoracic rib cage to the front of the patient and go up and attach to unweighting system via connector (7). Connector (7) is configured to enable adjusting of tensioning of the band. Pads (20) and (21) further distribute pressure around sensitive anatomical points. The band connects to the thoracic belt on the back side of the user. Optionally, the band connects to the thoracic belt at approximately the midpoint of the band. The band is configured to drape down from the unweighting system towards the should of the user, under the arm of the user, and to attach to the thoracic belt on the back of the user. When the unweighting system is used, the band may not touch the armpit of the user. The band is kept in place by the cross-forces exerted on the front of the band via the connectors to the thoracic belt on the front of the user's body.

Two straps extend down from the unweighting system behind the user. Each strap is connected to the unweighting system via a connector on one end. The end of the strap opposite the end of the strap connected to the unweighting system is configured to connect to the other strap. This connector may optionally be a buckle. The two straps connect in the front of the user, via the connector. The two straps are connected to the belt on the back side of the user. The connection between the two straps and the belt may compromise a clip with slots. The clip may be attached to the belt via a loop of fabric and may be composed of a plastic or metal material. The slots in the clip may enable a loop of fabric to go around one of the two straps and through out of the slots, such that the loop of fabric secures a strap to a slot via the loop of fabric. The two straps pass around the sides of the user to the front of the user. The two straps sit directly below the rib cage of the user.

Force is applied to the two straps via the unweighting system, in substantially a vertical direction. As this force is applied, the two straps cinch around the user just below the rib cage. This force simultaneously tightens the two straps around the user, to prevent the user from slipping downward, and lifts the user. Utilizing the reinforced and/or elasticized straps (5) with this positioning (6) to accomplish this unweighting has the effect of evenly distributing forces and snugging up or hugging the user.

The elastic portion (9) of the strap allows for the hugging effect while the reinforced portion (10) comes into play once a certain amount of force is applied and everything is secured. Then total body weight can be removed without fear of exceeding elastic capabilities of elastic portion of band. Two elasticized and/or reinforced bands (11) and (12) with means to connect together (13) and (14) will go from anterior patient wrapping around each side of patient to back of patient going through connector (15) and connecting to unweighting device via connectors (16) and (17). When an unweighting force is applied to these straps a tensioning force will distribute forces uniformly across entire portion of strap(11) and strap(12) and hugging action occurs. Again the elasticized portion of the strap allows for the hugging and securing activity while the reinforced portion allows for unweight forces to exceed the normal limits of the elasticized portion in a safe manner. The adjustment straps (18) on front of vest connecting to strap (19) are adjustable to control where straps (11) and (12) falls relative to sensitive anatomical points. Adjustable straps (8) and (22) are designed to allow uniform tension between band (5) and straps (11) and (12) or uneven depending on what user is trying to do with patient. As an exemplary use, one strap may be elongated via the adjustable straps, and such an elongation may cause one side, such as the right side, of the user to be lifted first, and be lifted higher than the other side of the user. The adjustable straps may cross on the back side of the user. The adjustable strap that connects to the right side of the unweighting device loops under the left arm of the user, and the adjustable strap that connects to the left side of the unweighting device loops under the right arm of the user.

The combination of the thoracic belt, the band, and the two straps is optionally called the vest.

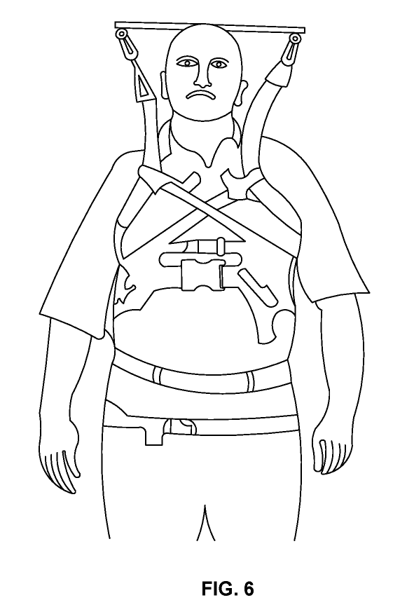

An ischial tuberosity strap (23) is shown in FIG. 6. The strap (23) is constructed of a non-slip material attached to a nylon strap (24). This attachment may be accomplished by stitching, adhesive, or other means. This nylon strap (24) will have the means for having a male (25) and female (26) buckle at each end. To this is a second nylon strap (27) is threaded through guides (28). This strap also has a standard male (29) and female (30) buckle at each end. This ischial tuberosity strap (23) has straps (31) with connectors that attached to the thoracic belt. These connectors may be male buckles (32) which allow it to be connected to female buckles (33) on vest (1). There may be four straps or more or less. One strap may connect to the thoracic belt in the front of the user on a right side of the user. One strap may connect to the thoracic belt in the back of the user on a right side of the user. One strap may connect to the thoracic belt in the front of the user on a left side of the user. One strap may connect to the thoracic belt in the back of the user on a left side of the user. The straps connected at the front of the user may hang and exert force at an angle. The straps connected at the back of the user may hand and exert force in substantially a vertical direction. The straps may loop around the second nylon strap. The subset of straps that connect at a right side of the user may be looped around the second strap at the same point. The subset of straps that connect at a left side of the user may be looped around the second strap at the same point. The straps may be secured to the ischial tuberosity strap via stitching, adhesive, or other means.

When these adjustable straps (31) are snugged up it allows for weight distribution between upper vest (1) and ischial tuberosity strap (23). The weight distribution between the vest and the ischial tuberosity strap may be such that the vest supports approximately half of the weight and the ischial tuberosity strap supports approximately half of the weight. The ischial tuberosity strap (23) is typically positioned and secured after patient is in a standing position. The design allows for non-slip (35) portion of the strap to be used as positioning and locator while the secondary strap (27) is the strap that serves to lock under the gluteal fold and be the primary holder.

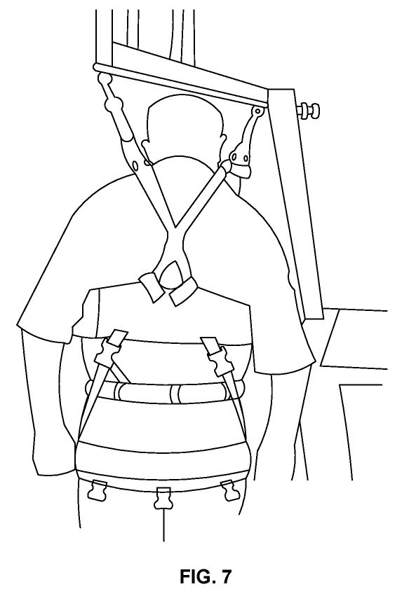

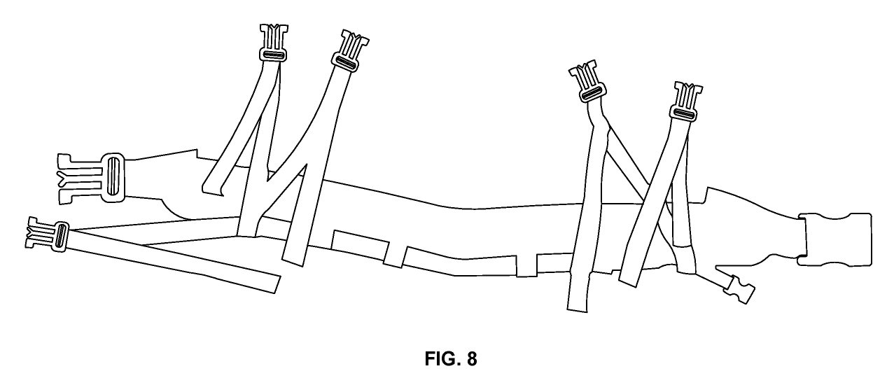

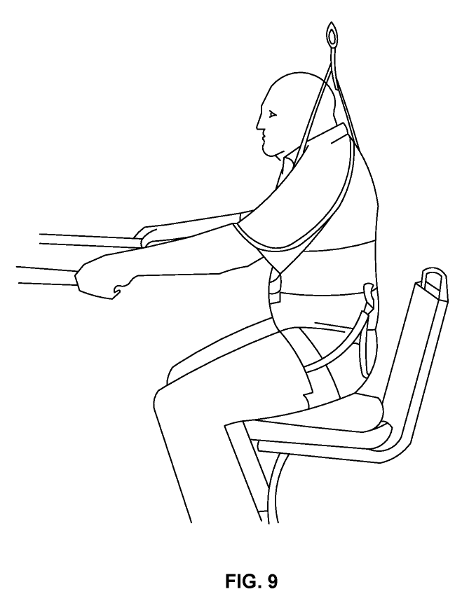

In using the present invention, the shoulder straps (36) are hung from an unweighting system which may be positioned over ground or over a treadmill. The unweighting system is positioned so that the vest (1) may be fitted on the person using the treadmill. This fitting may be done in either in a standing or seated position. The person is faced so that the person can back into the vest. The right arm is positioned through the right shoulder strap (37), and the left arm is positioned through the left shoulder strap (38). Thoracic belt is then fastened around patient's abdomen via connectors (2) and (3) and secured in place. Straps (11) and (12) are joined and minimal weight is removed to tension and secure vest (1) in place. Positioning straps (39) and (40) are secured and tensioned to desired positioning. Unweighting system is now adjusted to remove desired amount of body weight} from minimal to full body weight. FIG. 7. This vest (1) is designed to be used with (FIG. 8) or without (FIG. 9) ischial tuberosity strap (23).

While an embodiment has been described with respect to a wheelchair, the vest may also be adapted and used in coordination with an existing chair such as an office chair, lumbar support chair, sofa or automobile seat. In such situation, some of the straps would be secured in a similar manner as described above and as required for automobile crash safety purposes.

Each of the straps and band described may be composed of nylon, or similar material. The connectors may be composed of buckles. Connections to the unweighting system may be configured as an eye and clip, a buckle, a hook with a strap looped through, or similar means. The straps may be elasticized or not. The straps may be reinforced or not.

What is claimed is:

1. A device for holding the body weight of a user comprising:
a vest comprising:
a) a belt having two ends and a connector at each of the two ends, wherein the connectors fit together on a front side of the user and the belt fits around the stomach area of the user;
b) the belt further comprising at least four connectors;
c) two straps comprising elasticized and reinforced material, each strap having a connector at each end of the straps, wherein the two straps:
connect on the front side of the user via one end of each strap;
the portion of the straps that are on the front and sides of the user are located directly below a rib cage of the user;
connect to an unweighting device via an opposite end of each strap;
connect to the belt on a back side of the user;
d) a band comprising elasticized and reinforced material, wherein the band:
connects to the belt on the front side of the user via a right side connecting mechanism and a left side connecting mechanism;
loops from the back side of the user, under the arms of the user, and upwards towards a shoulder of the user;
connects to the unweighting device via each end of the band;
connects to the belt on the back side of the user in approximately the midpoint of the band;
further comprises a right side pad and a left side pad, configured to distribute pressure, wherein the right side connecting mechanism is attached to the left side pad and the left side connecting mechanism is attached to the right side pad; and
an ischial tuberosity strap comprising:
a) a nylon strap having two ends, a connector at each of the two ends, and at least one side comprising non-slip material, wherein the connectors fit together on the front side of the user and the nylon strap fits around an ischial region of the user;
b) loops on the bottom of the nylon strap;
c) a second nylon strap fed through the loops of the nylon strap, further comprising two ends and a connector at each of the two ends, where in the connectors fit together on the front side of the user and the second nylon strap fits around the ischial region of the user;
d) at least four attaching straps connecting the ischial tuberosity strap to the vest, wherein each of the attaching straps has a connector at one end that connects to the at least four connectors of the belt and is attached to the ischial tuberosity strap via looping around the second nylon strap or stitching to the nylon strap;
e) wherein the second nylon strap is positioned below a gluteal region of the user and the nylon strap is positioned in the gluteal region of the user.

2. A vest for holding the body weight of a user comprising:
a) a belt having two ends and a connector at each of the two ends, wherein the connectors fit together on a front side of the user and the belt fits around the stomach area of the user;
b) the belt further comprising at least four connectors;
c) two straps, each strap having a connector at each end of the straps, wherein the two straps:
connect on the front side of the user via one end of each strap;
the portion of the straps that are on the front and sides of the user are located directly below a rib cage of the user;
connect to an unweighting device via an opposite end of each strap;
connect to the belt on a back side of the user;
d) a band comprising elasticized and reinforced material, wherein the band:
connects to the belt on the front side of the user via a right side connecting mechanism and a left side connecting mechanism;
loops from the back side of the user, under the arms of the user, and upwards towards a shoulder of the user;
connects to the unweighting device via each end of the band;
connects to the belt on the back side of the user in approximately the midpoint of the band;
further comprises a right side pad and a left side pad, configured to distribute pressure, wherein the right side connecting mechanism is attached to the left side pad and the left side connecting mechanism is attached to the right side pad;

3. The vest of claim 2, wherein the two straps comprise elasticized and reinforced material.

4. The vest of claim 2, wherein the unweighting device exerts pressure on the user through the portion of the two straps that are on the front and sides of the user.

5. The vest of claim 2, wherein the right side connecting mechanism connects to the left side of the belt and wherein the left side connecting mechanism connects to the right side of the belt.

6. The vest of claim 2, wherein the two straps connect to the belt via a clip.

7. The vest of claim 2, wherein the two straps connect to the belt via respective loops of material, wherein each strap passes through a loop of material.

8. The vest of claim 7, wherein the respective loops of material connect to the belt via a clip.

9. The vest of claim 7, wherein the respective loops of material connect to the belt via stitching.

10. The vest of claim 2, wherein the two straps cross on the back side of the user, wherein the strap that connects to the right side of the unweighting device loops under the left arm of the user, and the strap that connects to the left side of the unweighting device loops under the right arm of the user.

11. The vest of claim 2, wherein the two straps and the band connect to the unweighting device via an eye and clip configuration.

12. The vest of claim 2, wherein the two straps and the band connect to the unweighting device via a buckle configuration.

13. The vest of claim 2, wherein the two straps, the band, and the belt are adjustable.

14. The vest of claim 2, wherein the two straps and the band connect to the unweighting device via looping through a hook configuration.

15. An ischial tuberosity strap for holding the body weight of a user comprising:
a) a strap having two ends, a connector at each of the two ends, and at least one side comprising non-slip material, wherein the connectors fit together on the front side of the user and the strap fits around an ischial region of the user;
b) loops on the bottom of the strap;
c) a second strap fed through the loops of the nylon strap, further comprising two ends and a connector at each of the two ends, where in the connectors fit together on the front side of the user and the second nylon strap fits around the ischial region of the user;
d) at least four attaching straps connecting the ischial tuberosity strap to the vest, wherein each of the attaching straps has a connector at one end that connects to the at least four connectors of the belt and is attached to the ischial tuberosity strap via looping around the second nylon strap or stitching to the nylon strap;
e) wherein the second nylon strap is positioned below a gluteal region of the user and the nylon strap is positioned in the gluteal region of the user

16. The ischial tuberosity strap of claim 15, wherein the strap, the second strap, and the at least four attaching straps comprise nylon.

17. The ischial tuberosity strap of claim 15, wherein the at least four attaching straps are configured such that at least one strap connects to a belt in the front of the user's right leg, at least one strap connects to the belt in the front of the user's left leg, at least one strap connects to the belt in the back of the user's right leg, and at least one strap connects to a belt in the back of the user's left leg.

18. The ischial tuberosity strap of claim 15, wherein at least two of the at least four attaching straps are configured to hang approximately vertical, and at least two of the at least four attaching straps are configured to hang at an angle.

19. The ischial tuberosity strap of claim 15, wherein each of a subset of the at least four attaching straps that are associated with a left or right side of a user's body connect to the second strap via the same loop.

20. The ischial tuberosity strap of claim 15, wherein the strap, the second strap, and the at least four attaching straps are adjustable.
